(19) United States
(12) Patent Application Publication
(10) Pub. No.: US 2026/0286943 A1
(43) Pub. Date: Sep. 24, 2026

(54) Dispensing Pump

(71) Applicant: Verity Packaging, Inc., San Marcos, CA (US)

(72) Inventor: David Hurrle, Carlsbad, CA (US)

(21) Appl. No.: 19/470,009

(22) PCT Filed: Mar. 27, 2024
(86) PCT No.: PCT/US2024/021793

§ 371 Date: Sep. 26, 2025

Related U.S. Application Data
(60) Provisional application No. 63/454,740, filed on Mar. 27, 2023.

(51) Int. Cl. F04B 9/14; B65D 47/00; F04B 53/10; F16K 21/06

(52) U.S. Cl. CPC F04B 9/14; B65D 47/00; F04B 53/10; F16K 21/06

(57) ABSTRACT

A dispensing pump includes a collar member and a valve member positionable in and axially movable relative to the collar member. The valve member includes an engagement portion including a flange portion. The dispensing pump also includes a translation member including a passageway. The engagement portion is positionable in and through the passageway of the translation member, a first sealing member is positionable on a first side of the flange portion and in the passageway of the translation member, a second sealing member is positionable against an outer portion of the translation member opposite of the first side of the flange portion and about the passageway, and a third sealing member is positionable in an outer groove of the translation member..

### CROSS-REFERENCES TO RELATED APPLICATIONS

The present application is a U.S. National Stage entry under 35 USC § 371 of PCT Application Serial No. PCT/US2024/021793, filed Mar. 27, 2024, which claims the benefit of priority to U.S. Provisional Patent Application Ser. No. 63/454,740, filed Mar. 27, 2023, the entire contents of which are hereby incorporated by reference into this disclosure as if set forth fully herein.

### FIELD

The present disclosure relates generally to a product dispensing pump.

### BACKGROUND

Unless otherwise indicated herein, the materials described herein are not prior art to the claims in the present application and are not admitted to be prior art by inclusion in this section.

Single use products may lead to increases in the amount of waste provided to landfills and, in turn, the amount of waste which ultimately finds its way into waterways and other natural features. In order to reduce such waste, there is an increasing need to provide reusable products, including those which may be used to dispense consumer product materials from a container.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, a dispensing pump includes a collar member and a valve member positionable in and axially movable relative to the collar member. The valve member includes an engagement portion including a flange portion. The dispensing pump also includes a translation member including a passageway. The engagement portion is positionable in and through the passageway of the translation member, a first sealing member is positionable on a first side of the flange portion and in the passageway of the translation member, a second sealing member is positionable against an outer portion of the translation member opposite of the first side of the flange portion and about the passageway, and a third sealing member is positionable in an outer groove of the translation member.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a dispensing pump;

FIG. 2 is a partially exploded, perspective view of the dispensing pump illustrated in FIG. 1;

FIG. 3 is a section view of the dispensing pump illustrated in FIG. 1 illustrating relative positioning of components thereof in a normal configuration;

FIG. 4 is an alternative section view of the dispensing pump illustrated in FIG. 1 illustrating relative positioning of components thereof in a partially depressed configuration;

FIG. 5 is another alternative section view of the dispensing pump illustrated in FIG. 1 illustrating relative positioning of components thereof in a fully depressed configuration;

FIG. 6 is a perspective view of an upper portion of the dispensing pump illustrated in FIG. 1; and

FIG. 7 is a section view of an alternative embodiment dispensing pump.

### DETAILED DESCRIPTION OF A PREFERRED EMBODIMENT

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to a product dispensing pump. It will be appreciated that embodiments disclosed herein may be employed in a variety of fields and/or operating environments where the functionality disclosed herein may be useful. Accordingly, the scope of the invention should not be construed to be limited to the exemplary implementations and operating environments disclosed herein.

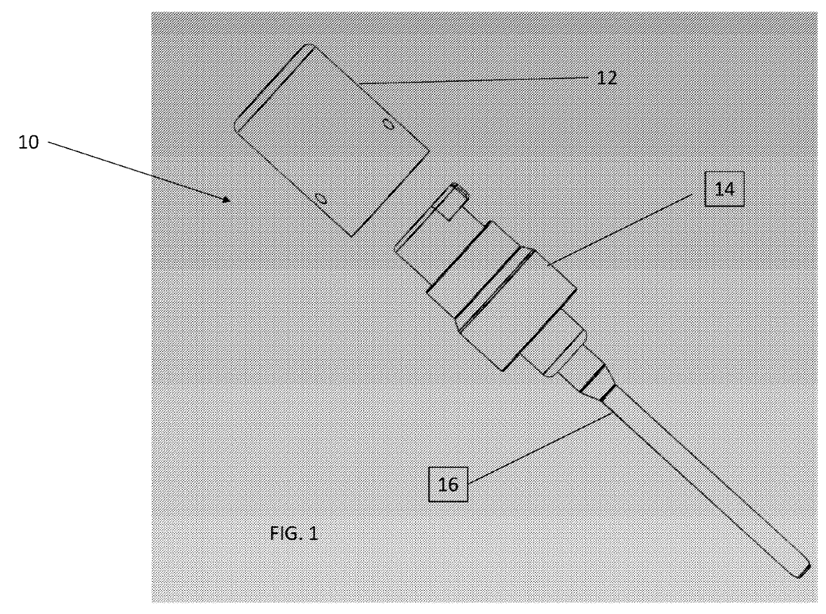

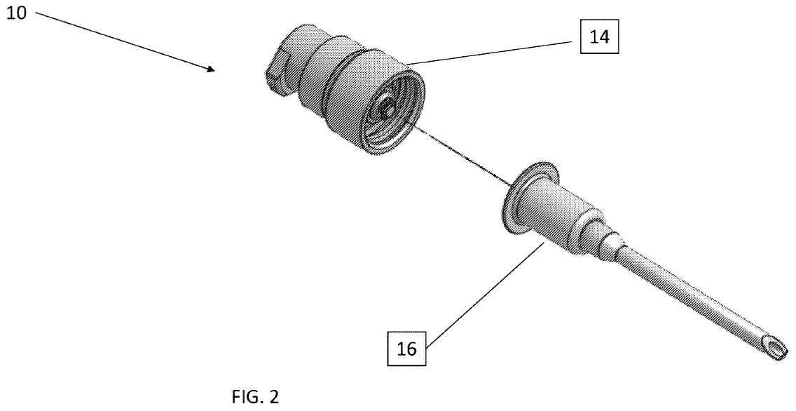

With general reference to FIGS. 1-7 for example, there is illustrated an example embodiment of a dispensing pump 10. Without limitation, and generally speaking, the dispensing pump 10 may be configured such that components thereof are formed of metal or metallic materials with the exception of various seals included therein, although it should be appreciated that variations in the materials used for construction of the dispensing pump 10 are possible and contemplated. In one form, the dispensing pump 10 may be entirely or substantially free of any plastic materials unless the same may be included in any of the sealing members described herein.

The dispensing pump 10 generally includes a cap member 12, a valve tube assembly 14 and a chamber tube assembly 16, where the cap member is configured to engage with the valve tube assembly 14 to cover an upper portion of the valve tube assembly 14. The dispensing pump 10 may be configured to engage with a container (not shown) containing (or configured to contain) a dispensable material in a configuration which facilitates dispensing of the material from the container upon activation of the dispensing pump 10.

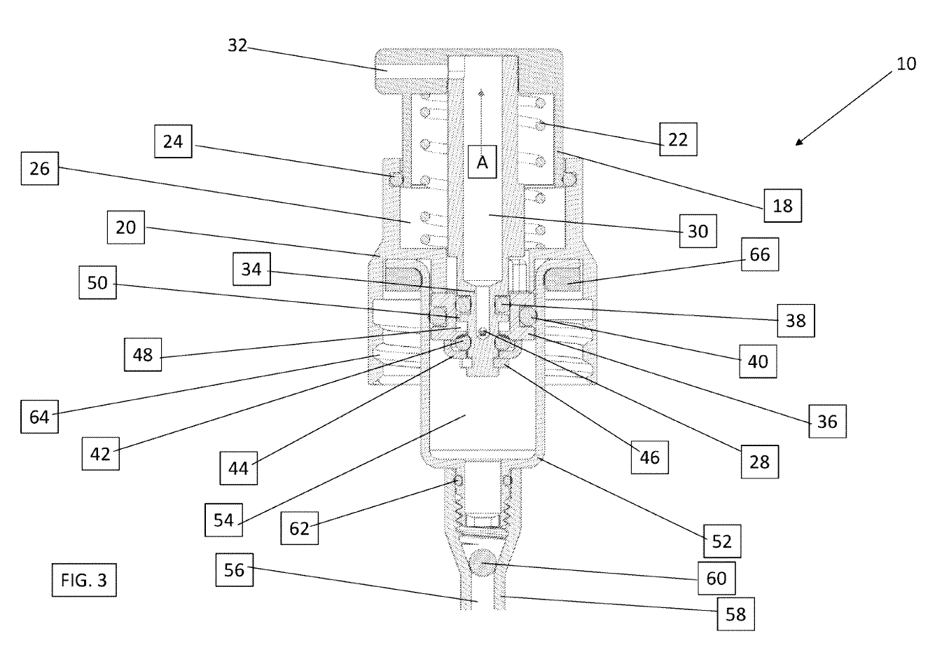

As illustrated in FIG. 3 for example, the valve tube assembly 14 includes a valve member 18 and a collar 20. A biasing member 22 is positioned between the collar 20 and the valve member 18 and biases the valve member 18 in a normal position relative to the collar 20 in the direction of directional arrow A illustrated in FIG. 3. However, upon application of sufficient force to the valve member 18, the biasing force of the biasing member 22 may be overcome in order to allow movement of the valve member 18 relative to the collar 20. The collar 20 includes an annular groove or similar feature configured to receive a sealing member 24, such as an elastomeric O-ring or similar component, at least a portion of which is positioned between the collar 20 and the valve member 18. The sealing member 24 may, amongst other things, prevent entrance of debris or other contaminants into a chamber 26 defined by the collar 20, prevent direct contact between the valve member 18 and the collar 20, and stabilize positioning of the valve member 18 in the collar 20 in the event force is applied to the valve member 18 in a direction transverse to the directional arrow A.

The valve member 18 includes an orifice 28 in fluid communication with an internal passageway or chamber 30 which is also in fluid communication with a discharge opening 32. In this arrangement, during operation of the dispensing pump 10 (further details of which will be provided below) a dispensable material may enter the orifice 28 and pass through the passageway 30 for discharge at the discharge opening 32. The valve member 18 further includes an engagement portion 34 and a translation member 36 configured to engage with or receive the engagement portion 34. For example, in the illustrated form the translation member 36 includes a passageway through which the engagement portion 34 extends. In the illustrated form, a sealing member 38, such as an elastomeric O-ring, is positioned in the passageway of the translation member and between the engagement portion 34 and the translation member 36 and may provide a friction fit therebetween. Moreover, the translation member 36 includes an annular groove or similar feature which is configured to receive a sealing member 40, such as an elastomeric O-ring.

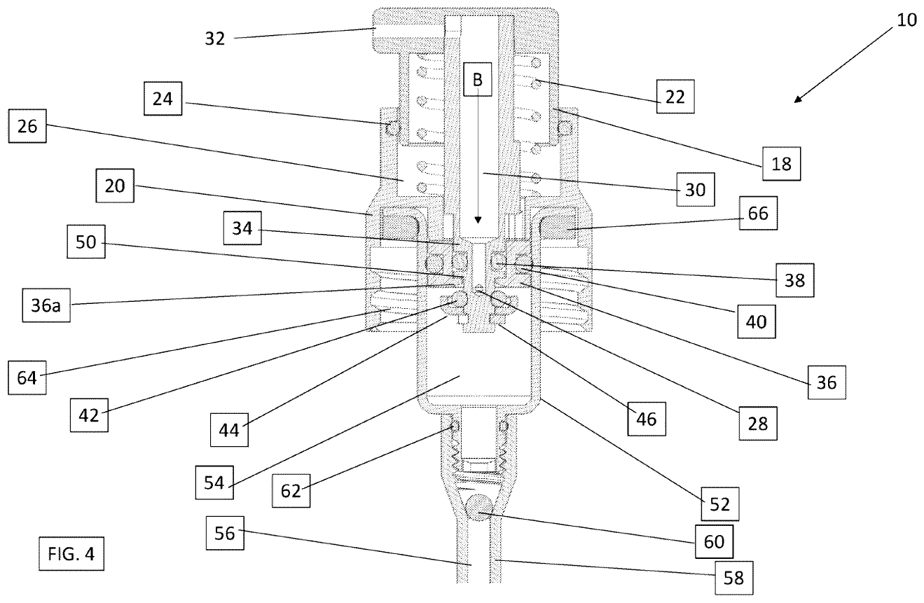

A sealing member 42, such as an elastomeric O-ring, is engaged with the engagement portion 34 is positioned against the translation member 36 in the normal position of the valve tube assembly 14 illustrated in FIG. 3 in an arrangement which prevents any dispensable material from entering the orifice 28 when the valve tube assembly 14 is in its normal position. In this arrangement, the sealing member 42 is positioned against and about an adjacent opening of the passageway of the translation member 36 in order to prevent passage of any dispensable material into the passageway of the translation member 36. As seen in FIG. 4 for example, the translation member 36 includes a chamfered portion 36a configured to receive a portion of the sealing member 42. Moreover, when the valve tube assembly is in its normal position as illustrated in FIG. 3, a gap or space 48 is positioned between a flange 50 of the engagement portion 34 and the translation member 36. A cap or closure member 44 is engaged with the engagement portion 34 and positioned over the sealing member 42, and the engagement portion 34 is further configured to receive a locking member 46, such as an e-ring, which is configured to retain engagement of the translation member 36 and the closure member 44 with the engagement portion 34.

The chamber tube assembly 16 includes a chamber member 52 which defines a chamber 54 configured to receive a dispensable material from a container. The chamber tube assembly 16 also includes an elongated tube member 56 including a hollow interior 58 configured to facilitate passage of a dispensable material therethrough from a container to the chamber 54. A flow control member 60 is positioned in a conical portion of the elongated tube member 56 and is movable between a position preventing passage of a dispensable material to the chamber 54 and a position allowing passage of a dispensable material to the chamber 54 depending on an operational state of the valve tube assembly 14. In the illustrated form, the chamber member 52 and the tube member 56 are coupled via a threaded engagement, although other variations for coupling these components together are contemplated. In this arrangement, various different lengths of the elongated tube member 56 may be interchanged to facilitate use of the dispensing pump 10 with various different container sizes. A sealing member 62 is positioned between the chamber member 52 and the tube member 56 to prevent leakage of dispensable material from the coupling of these components.

In the illustrated form, the chamber 54 is sized and configured such that the sealing member 40 positioned about the translation member 36 provides a friction fit engagement between the valve tube assembly 14 and the chamber tube assembly 16. In addition, the collar 20 includes an internally threaded portion 64 configured to engage with an externally threaded portion of a container. In this configuration, as the collar 20 is engaged with the container, the container comes into contact with a gasket 66 to provide a seal with the container. In addition, engagement of the container with the collar 20 also secures engagement of the valve tube assembly 14 and the chamber tube assembly 16.

As indicated above, FIG. 3 provides an illustration of the valve tube assembly 14 in its normal position. However, application of sufficient force on the valve member 18 may overcome the biasing force of the biasing member 22 and change the relative positioning between the valve member 18 and the collar 20. For example, as illustrated in FIG. 4, as a force is applied to the valve member 18 in the direction indicated by directional arrow B, the flange 50 is moved into engagement with the translation member 36 and the orifice 28 is moved out of the translation member 36 and into fluid communication with the chamber 54. In this arrangement, any dispensable material in the chamber 54 may begin to flow into the orifice 28. Moreover, while not previously discussed, it should be appreciated the friction fit provided between the chamber 54 and the sealing member 40 prevents movement of the translation member 36 as the flange 50 is moved into engagement with the translation member 36.

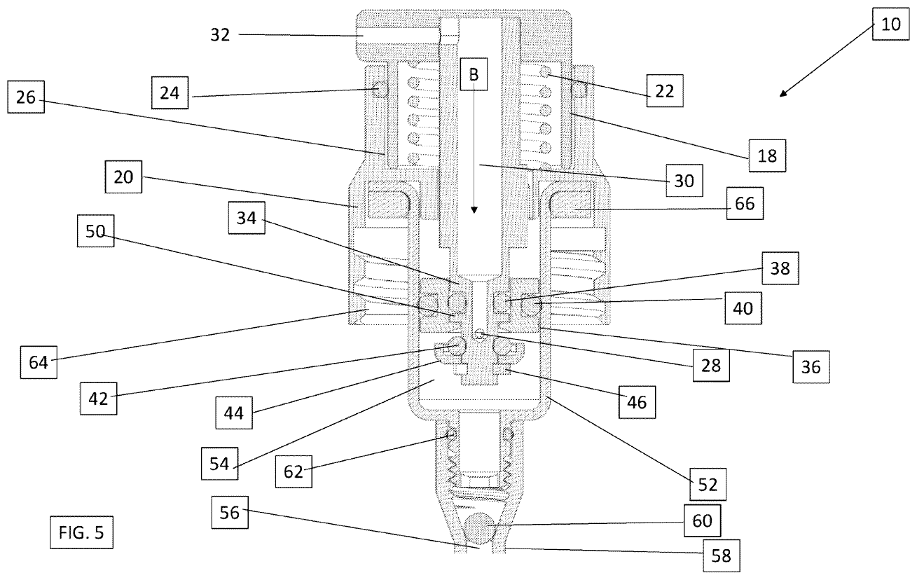

With reference now to FIG. 5, upon application of continued or additional force on the valve member 18 in the direction indicated by directional arrow B, the orifice 28 is further moved into the chamber 54. In addition, engagement of the flange 50 with the translation member 36 results in transfer of force from the valve member 18 to the translation member 36 and movement of the translation member 36 in the chamber 54 and relative to the chamber member 52. The valve member 18 may be moved in the direction of directional arrow B until it contacts the collar 20 in the chamber 26 which prevents further movement of the valve member 18 relative to the collar 20 in the direction of directional arrow B. As the translation member 36 is moved in the chamber 54, material in the chamber 54 is forced into the orifice 28 and through the passageway 30 for discharge at the discharge opening 32. At the same time, the flow control member 60 remains in a position preventing passage of a dispensable material to the chamber 54.

When force is released from the valve member 18, the biasing member 22 returns the valve member 18 to its normal position illustrated in FIG. 3, and the orifice 28 is sealed from the chamber 54, preventing passage of additional material into the orifice 28. As the valve member 18 returns to its normal position, the flow control member 60 is moved toward the valve member 18 in order to allow passage of a dispensable material from a container into the chamber 54. When the valve member 18 returns to its normal position, the flow control member 60 returns to a position preventing passage of a dispensable material into the chamber 54.

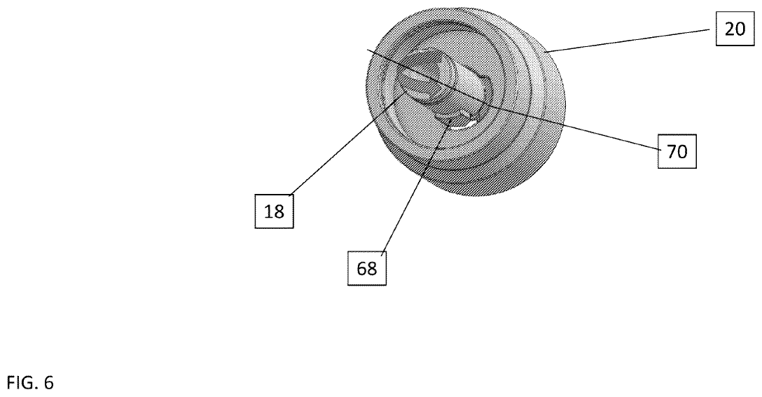

While not previously discussed, it should be appreciated that the amount of dispensable material released from the discharge opening 32 on each stroke of the valve member 18 relative to the collar 20 may be at least partially dependent on the length of the stroke. Stated alternatively, the amount of dispensable material released from the discharge opening 32 may at least partially depend on the amount the valve member 18 may travel in the chamber 26 of the collar 20 before the valve member 18 comes into contact therewith and its further movement is prevented. As such, in one form, the size or length of the chamber 26 may be changed in order to change the amount of dispensable material which is released from the discharge opening 32. For example, one or more spacers may be positioned in the chamber 26 to change the size or length thereof. Alternatively, the size or length of the valve member 18 may be altered in order to change the relative stroke length between the valve member 18 and the collar 20. In one form for example, a press fit ring or similar feature may be added to the lower end of the valve member during assembly to elongate the valve member and reduce the relative stroke length between the valve member 18 and the collar 20. With reference to FIG. 6, the valve member 18 includes a raised projection 68 and the collar 20 includes a corresponding recess 70 configured to receive the raised projection 68 upon rotation of the valve member 18 relative to the collar 20. In this arrangement, engagement of the raised projection 68 against the collar 20 prevents displacement or movement of the valve member 18 in the chamber 26 of the collar 20. Similarly, this arrangement may prevent inadvertent use of the dispensing pump 10.

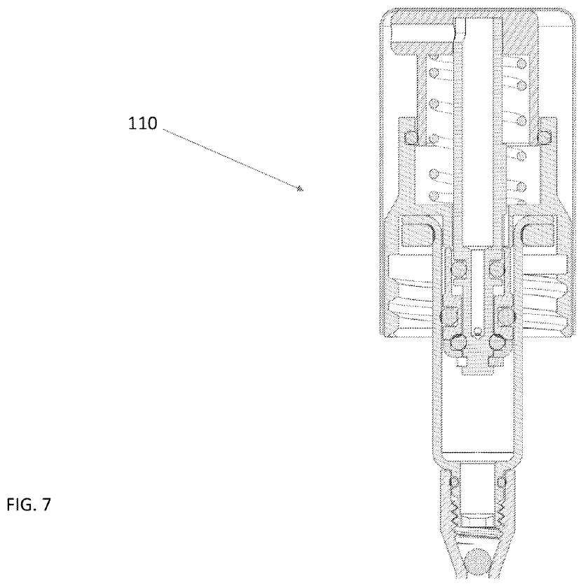

An alternative embodiment dispensing pump 110 is illustrated in FIG. 7. The dispensing pump 110 is substantially similar to the dispensing pump 10 and includes corresponding features and functions to those described in connection with the dispensing pump 10. However, the dispensing pump 110 is configured to engage with a container having a smaller opening and corresponding threads relative to the configuration of the dispensing pump 10. In this arrangement, a portion of the valve member and the material chamber have a reduced width or diameter relative to that in the dispensing pump 10. Given this reduction, the volume of the dispensable material which may be released upon each pump stroke will be less than the corresponding amount associated with the dispensing pump 10 if the pump stroke length is the same between the dispensing pump 10 and the dispensing pump 110. However, it should be appreciated that the dispensing pump 110 may be configured with a longer pump stroke length relative to that of the dispensing pump 10 in order to achieve the same volume of dispensable material released therefrom per each pump stroke.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dispensing pump, comprising:
a collar member;
a valve member positionable in and axially movable relative to the collar member, the valve member including an engagement portion including a flange portion; and
a translation member including a passageway;
wherein the engagement portion is positionable in and through the passageway of the translation member, a first sealing member is positionable on a first side of the flange portion and in the passageway of the translation member, a second sealing member is positionable against an outer portion of the translation member opposite of the first side of the flange portion and about the passageway, and a third sealing member is positionable in an outer groove of the translation member.

2. The dispensing pump of claim 1, further comprising a chamber tube assembly including a chamber member defining a chamber in which at least a portion of the valve member is positionable.

3. The dispensing pump of claim 2, wherein the third sealing member engages with a portion of the chamber to provide a friction fit between the valve member and the chamber tube assembly.

4. The dispensing pump of claim 3, wherein the valve member includes an orifice configured to receive a dispensable material from the chamber.

5. The dispensing pump of claim 4, wherein in a normal positioning of the valve member relative to the collar member fluid communication of the orifice with the chamber is prevented.

6. The dispensing pump of claim 5, wherein initial axial displacement of the valve member relative to the collar member places the orifice in fluid communication with the chamber.

7. The dispensing pump of claim 6, wherein further axial displacement of the valve member relative to the collar member positions the flange portion into contact with the translation member and displaces the translation member in the chamber.

8. The dispensing pump of claim 5, further comprising a biasing member positioned between the valve member and the collar member, the biasing member providing a biasing force to maintain normal positioning of the valve member relative to the collar member.

9. The dispensing pump of claim 1, wherein the collar member includes an internally threaded portion configured to engage with a container.

10. The dispensing pump of claim 1, further comprising a clip member engageable with the engagement portion of the valve member and configured to retain engagement of the translation member and the engagement portion.

11. The dispensing pump of claim 1, further comprising a chamber tube assembly including a chamber member and an elongate tube extending therefrom, the chamber member including a laterally extending flange configured to engage against a portion of the collar member.

12. The dispensing pump of claim 11, wherein the collar member includes an internally threaded portion configured to engage with a container and the laterally extending flange is positioned between the collar member and the container when the collar member is engaged therewith in an arrangement securing engagement of the chamber tube assembly and the valve member.
